(19) United States
(12) Patent Application Publication
(10) Pub. No.: US 2009/0166943 A1
(43) Pub. Date: Jul. 2, 2009

(54) Cutting board

(76) Inventor: Oleg Raschkov, Salzburg (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/314,788

(22) Filed: Dec. 16, 2008

(30) Foreign Application Priority Data
Dec. 20, 2007 (AT) A 2080/2007

(51) Int. Cl. A47J 43/00

(52) U.S. Cl. 269/290

(57) ABSTRACT

The invention relates to a multipart cutting board, comprising at least one whetting device for cutting tools, especially kitchen knives, with at least a first part of the cutting board being connected through the whetting device with at least a second part of the cutting board.

The invention relates to a multipart cutting board with a whetting device for cutting tools, especially kitchen knives.

When preparing dishes such as the cutting of meat, fish or vegetables, a knife will often quickly become blunt and needs to be whetted and sharpened. For the sharpening of knives and scissors there are numerous apparatuses such as whetstones, sharpening steel or also electric grinding devices with rotating whetstones.

The disadvantageous aspect in such devices is however that they are often not readily available and often require a fair amount of space in the kitchen. It is therefore advantageous to integrate a whetting device directly in the cutting board in order to readily have a possibility to whet the knife when a whetting device is needed.

JP 2006-159395 shows a cutting board with a whetstone or abrasive paper which is arranged on the surface of the cutting board.

JP 2005-334577 describes a cutting board with a knife sharpener which is arranged in a corner region of the cutting board in a trough-like recess which extends parallel to one edge of the cutting board and not over the entire length of the cutting board.

The disadvantageous aspect in this state of the art is that the grinding dust occurring during the whetting of the kitchen knife accumulates on the cutting board or in the recess. They can be cleaned with much difficulty, leading to problems in respect of hygiene regulations in restaurants and inns for example. Moreover, it allows whetting the knife only in one direction and under an angle which is not advantageous because the recess in which the knife sharpener is arranged is sealed off in the region of the tip of the knife.

It is therefore the object of the invention to provide a cutting board with an improved sharpening device which eliminates the disadvantages of the state of the art as mentioned above.

This object is achieved by a multipart cutting board of the kind mentioned above in accordance with the invention in such a way that a first part of the cutting board is connected with a second part of the cutting board via the whetting device. A gap is disposed between the first and second part in which the whetting device is arranged which thus joins the two parts with each other. As a result, the grinding dust does not contaminate the foodstuff situated on the cutting board, but falls through the gap onto the worktop on which the cutting board has been placed. It can simply be mopped up from there. Similarly, this arrangement of the whetting device allows a grinding of the knife from all directions and under different angles, irrespective of whether the user is left-handed or right-handed.

Preferably, the whetting device comprises at least two whetting knives which, arranged at an angle with respect to each other, are housed in a support with a recess for guiding through an object to be sharpened. Said whetting knives are made of a hard, but easily breakable material. In order to ensure for example that during the lifting of the cutting board the weight of the second part does not rest on the whetting knives and would thus lead to their possible breaking, they are housed in a support to which the load is transferred. The recess in the support is dimensioned in such a way that guiding through a knife for example is possible without any limitation with respect to direction or angle, so that optimal grinding is possible.

This support is arranged in a preferred embodiment of the invention at least in two parts, with each part having a recess for receiving a whetting knife each. If the whetting knives need to be exchanged because they are worn for example, the support is disassembled, the whetting knives are removed from the recess in the support and exchanged. The recess in each part of the support further ensures that the whetting knives are always aligned at the optimal angle with respect to each other in the support.

As already mentioned above, the support of the whetting device is arranged between the two parts of the cutting board, with each part of the cutting board having a recess for receiving the support of the whetting device. When exchanging the whetting knives, the two parts are separated and the support is taken out of the recess. This allows for a rapid and simple exchange of the whetting device. It can thus be provided for example that different whetting knives are provided in a separate support for different knives, so that merely the supports need to be changed in order to enable the whetting of the respective knife on the cutting board.

In an especially preferred manner, the cutting board has a polygonal, especially a quadrangular or pentagonal shape, with a corner segment being separated from the cutting board and being connected via the whetting device with the same. By arranging the whetting device in a corner region of the cutting board, with the gap not extending parallel but under an angle relative to the adjacent edges of the cutting board, the whetting device is accessible substantially from all sides and is thus extremely flexible in its handling.

As an alternative thereto, the cutting board is arranged in a circular or elliptical manner in another embodiment of the invention, with a circular or ellipsoid segment being separated from the cutting board and being connected with the same through the whetting device.

The invention is now explained in closer detail by reference to non-limiting embodiments with the relevant drawings, wherein:

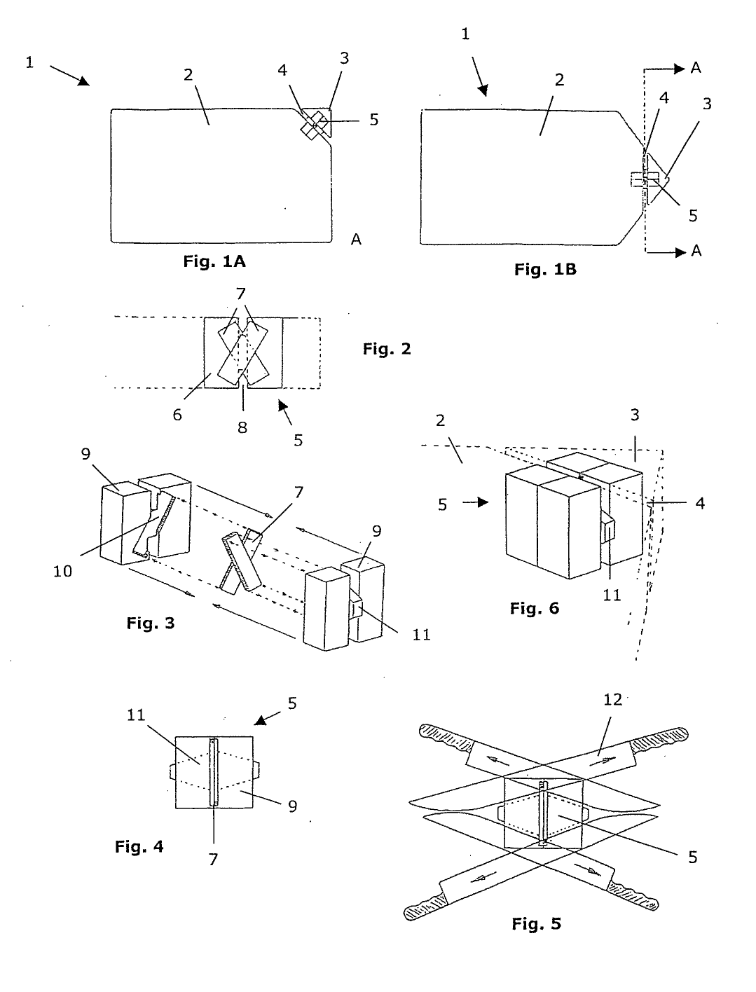

FIG. 1A and FIG. 1B show two embodiments of the cutting board in accordance with the invention;

FIG. 2 shows the whetting device from FIG. 1A and FIG. 1B in a view along line A-A;

FIG. 3 shows the whetting device in an exploded view;

FIG. 4 shows the whetting device in the assembled state;

FIG. 5 shows the use of the whetting device during the grinding of a knife, and

FIG. 6 shows the whetting device in the installed state.

The cutting boards shown in FIGS. 1A and 1B, preferably made of plastic, are provided with a two-part arrangement, comprising a first part 2 on which foodstuff is cut for example and a second part 3 which is arranged as a triangular corner segment and is spaced from the first part 2 through a gap 4. The corner segment 3 is connected through the whetting device 5 with the first part 2, which is the actual cutting board.

FIG. 2 shows the sharpening device 5 in a view along the line A-A, which means along the gap 4. Two sharpening knives 7 are housed in a support 6, with the two whetting knives 7 being arranged with respect to each other about a common axis which extends substantially through the central point of the two whetting knives 7 twisted about an angle which is optimal for whetting. The support 6, which is made of plastic or any other material for example, comprises a recess 8 through which a knife to be whetted is guided, so that the blade of the knife is whetted on the edges of the whetting knives 7.

The sharpening device 5 consists according to FIG. 3 of two support parts 9 between which the sharpening knives 7 are arranged, as is also shown in FIG. 4 which shows a side view of the assembled whetting device 5.

Each support part 9 comprises a recess 10 into which a whetting knife 7 can be inserted, by means of which the whetting knives 7 are positioned in the support 6 in a stationary manner. Furthermore, a substantially wedge-like guide element 11 is additionally provided in each support part 9, along which the knife 12 to be whetted is guided, as is also shown in FIG. 5.

FIG. 6 finally again shows the installed position of the whetting device 5 in the cutting board 1 in a perspective view. The guide elements 11 are arranged in this case in the gap 4 between the first and second part 2, 3 of the cutting board 1, while the whetting edges of the whetting knives 7 are arranged normally thereto.

It is understood that the described embodiments shall not be understood as being limiting in any way. It is also possible that several whetting devices are provided in a cutting board for example. The present invention is also not limited to the illustrated embodiment of the whetting device. The relevant aspect of the invention is that the whetting device is arranged in a cutting board in such a way that it is accessible from all possible sides without any limitation for the cutting tool to be whetted, with no contamination occurring of the cutting board surface and the foodstuff situated thereon.

What is claimed is:

1. A multipart cutting board, comprising at least one cutting device for cutting tools, especially kitchen knives, wherein at least a first part of the cutting board is connected through the whetting device with at least a second part of the cutting board.

2. A cutting board according to claim 1, wherein the whetting device comprises at least two whetting knives which, arranged at an angle with respect to each other, are housed in a support with a recess for guiding through an object to be whetted.

3. A cutting board according to claim 2, wherein the support is arranged at least in two parts, with each part of the support having a recess for receiving a whetting knife each.

4. A cutting board according to claim 2, wherein each part of the cutting board has a recess for receiving the support of the whetting device.

5. A cutting board according to claim 1, wherein it has a polygonal shape, especially quadrangular or pentagonal, with a substantially triangular corner segment being separated from the cutting board and being connected with the same through the whetting device.

6. A cutting board according to claim 1, wherein it has a circular or elliptical shape, with a circular or elliptical segment being separated from the cutting board and being connected with the same through the whetting device.
